(19) United States
(12) Patent Application Publication
(10) Pub. No.: US 2004/0105039 A1
(43) Pub. Date: Jun. 3, 2004

(54) Variable optical attenuator

(76) Inventors: Gonzalo Wills, Ottawa (CA); Oleg Bouevitch, Ottawa (CA)

Correspondence Address: Teitelbaum & MacLean, Registered Patent Agents Limited, 3000 Merivale Road, Ottawa, Ontario, K2G 6N7, CA

(21) Appl. No.: 10/627,783

(22) Filed: Jul. 28, 2003

Related U.S. Application Data
(60) Provisional application No. 60/398,826, filed on Jul. 29, 2002.

(51) Int. Cl. G02F 1/1335

(52) U.S. Cl. 349/9

(57) ABSTRACT

The invention relates to a variable optical attenuator utilizing a variable polarization rotator, preferably in the form of a liquid crystal cell, positioned between two birefringent elements, preferably in the form of two similar birefringent crystals. The first birefringent element splits a beam light into orthogonally polarized sub-beams, which are passed through the liquid crystal cell, thereby undergoing a desired polarization rotation. The second birefringent element recombines only a portion of each of the first and second sub-beams providing the desired amount of light as an output beam. To minimize insertion loss, a first lens is positioned between the first birefringent element and the liquid crystal cell, and a second lens is positioned between the liquid crystal cell and the second birefringent crystal. Ideally the liquid crystal cell is positioned a focal length away from the first lens, whereby both the first and second sub-beams enter the liquid crystal cell at the same point of entry, thereby minimizing polarization dependent loss (PDL) due to any anisotropy in the liquid crystal.

### CROSS-REFERENCE TO RELATED APPLICATIONS

The present invention claims priority from U.S. Patent Application No. 60/398,826 filed Jul. 29, 2002.

### TECHNICAL FIELD

The present invention relates to a variable optical attenuator, and in particular to a multi-port polarization independent variable optical attenuator.

### BACKGROUND OF THE INVENTION

Variable optical attenuators, such as the one illustrated in FIG. 1 and disclosed in U.S. Pat. No. 4,410,238 issued Oct. 18, 1983 to Eric Hanson, include a first birefringent crystal 32 for dividing an input beam of light 36 into to orthogonally polarized sub-beams 37 and 38; a liquid crystal cell 31 for adjusting the polarization of the two sub-beams 37′ and 38′; and a second birefringent crystal 33 for dividing each sub-beam 37′ and 38′ into orthogonally polarized components 43, 47 and 44, 48, respectively, and for recombining components 43 and 44, while spilling off unwanted light 47′ and 48′. Air gaps 51 separate the first and second birefringent crystals 32 and 33 from the liquid crystal cell 31.

Unfortunately, the Hanson device suffers from relatively high insertion loss as a result of poor coupling between the input and output fibers. Moreover, as a result of anisotropy in the liquid crystal, the polarization dependent loss (PDL) can also be quite significant, as the two sub-beams 37′ and 38′ will pass through different sections of the liquid crystal 31.

An object of the present invention is to overcome the shortcomings of the prior art by providing a variable optical attenuator with better coupling between the input and the output.

Another object of the present invention is to provide a variable optical attenuator with low PDL resulting from directing both of the sub-beams through the liquid crystal at the same point.

### SUMMARY OF THE INVENTION

Accordingly, the present invention relates to A variable optical attenuator device comprising:

an input port for launching an input beam of light;

a polarization beam splitter for dividing the input beam into first and second orthogonally polarized sub-beams;

a first lens for collimating the first and second sub-beams, and for redirecting the first and second sub-beams along converging paths;

a variable polarization rotator disposed in the crisscrossing paths for rotating the polarization of the first and the second sub-beam by a desired amount, whereby each of the first and second sub-beams has first and second orthogonally polarized components;

a second lens for focusing the first and second sub-beams, and for redirecting the first and second sub-beams along substantially parallel paths;

a polarization beam combiner disposed in the parallel paths for combining the first component of the first sub-beam with the second component of the second sub-beam into an output beam; and

an output port for outputting the output beam.

### BRIEF DESCRIPTION OF THE DRAWINGS

The invention will be described in greater detail with reference to the accompanying drawings which represent preferred embodiments thereof, wherein:

FIG. 1 is a conventional variable optical attenuator;

FIG. 2 is an isometric view of a variable optical attenuator according to the present invention;

FIG. 3 is a polarization map of the variable optical attenuator according to FIG. 2, with full attenuation;

FIG. 4 is a side view of the variable optical attenuator according to FIGS. 2 and 3;

FIG. 5 is a polarization map of the variable optical attenuator according to the present invention, with no attenuation;

FIG. 6 is a side view of the variable optical attenuator according to FIG. 5;

FIG. 7 is a side view of the variable optical attenuator according to the present invention, with partial attenuation;

FIG. 8 is an isometric view of an array of variable optical attenuators according to the present invention;

FIG. 9 is a side view of a reflected version of the variable optical attenuator according to the present invention;

FIG. 10 is an isometric view of another embodiment of a reflected version of the variable optical attenuator according to the present invention;

FIG. 11 is a top view of an array of the variable optical attenuators according to FIG. 10; and

FIG. 12 is a side view of the array of variable optical attenuators according to FIG. 11.

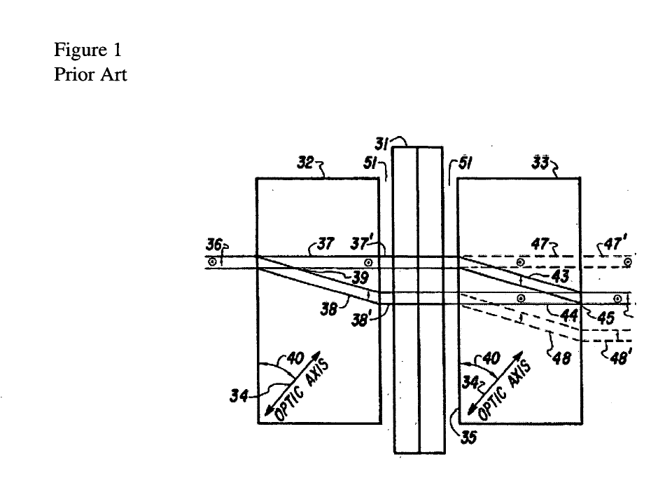

### DETAILED DESCRIPTION

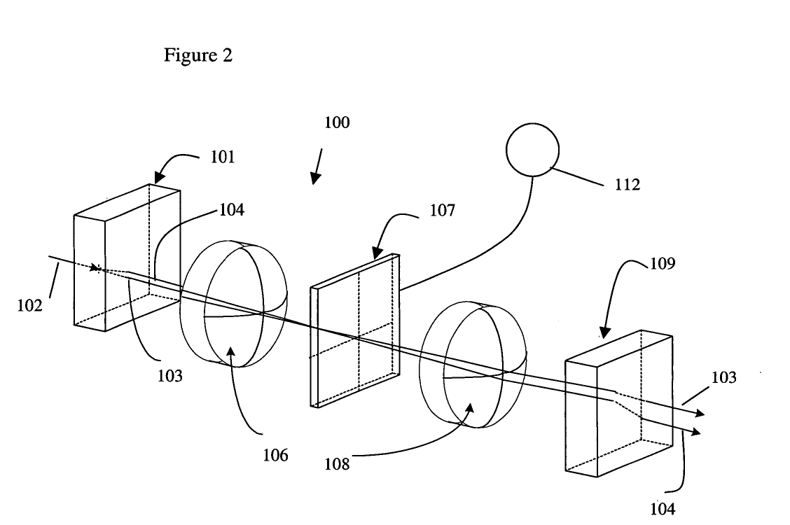

With reference to FIGS. 2 to 7, the variable optical attenuator 100 according to the present invention includes a first polarization beam splitter, preferably in the form of a first birefringent crystal 101, receiving an input beam of light from an optical waveguide 102. The first birefringent crystal 101 divides the input beam of light into two orthogonally polarized sub-beams 103 and 104. For illustration purposes, sub-beam 103 is horizontally polarized, while sub-beam 104 is vertically polarized, although other variations are possible depending on the orientation of the optical axis of the first birefringent crystal 101. A first lens 106 is disposed to receive the first and second sub-beams 103 and 104 on opposite sides of the optical axis 105 thereof, whereby the first and second sub-beams 103 and 104 are redirected as collimated beams along converging paths, which crisscross and then diverge. A variable polarization rotator 107, preferably in the form of a twisted nematic liquid crystal cell, is positioned in the paths of the sub-beams 103 and 104, preferably a focal length from, i.e. in the focal plane of, the first lens 106, so that both sub-beams 103 and 104 enter the variable polarization rotator 107 at the same point, which minimizes any PDL caused by anisotropy in the liquid crystal. Depending on the mode field diameter (MFD) used and the thickness of the birefringent crystal 101, the sub-beams 103 and 104 will be very close to intersecting after passing through the first lens 106, so the PDL will be greatly reduced even if the variable polarization rotator 107 is not placed exactly at the focal plane of the lens 106. The variable polarization rotator 107, under the control of variable controller 112, changes the state of polarization (SOP) of the sub-beams 103 and 104 to a desired state depending upon the amount of output light required. The sub-beams 103 and 104, with potentially altered SOPs, exit the variable polarization rotator 107, propagate along diverging paths in collimated space, and intersect a second lens 108 on opposite sides of the optical axis 110 thereof. The second lens 108 focuses the sub-beams 103 and 104 from collimated space to converging space, and directs them along parallel paths to a polarization beam combiner, in the form of a second birefringent crystal 109. Ideally the sub-beams 103 and 104 enter and exit the lenses 106 and 108 symmetrical with respect to the optical axes thereof 105 and 110, respectively, to enable all of the elements of the attenuator 100 to be aligned therealong. The polarization beam combiner 109 recombines the desired amount of light from each sub-beam 103 and 104 for output an output waveguide 111, while spilling-off any unwanted light.

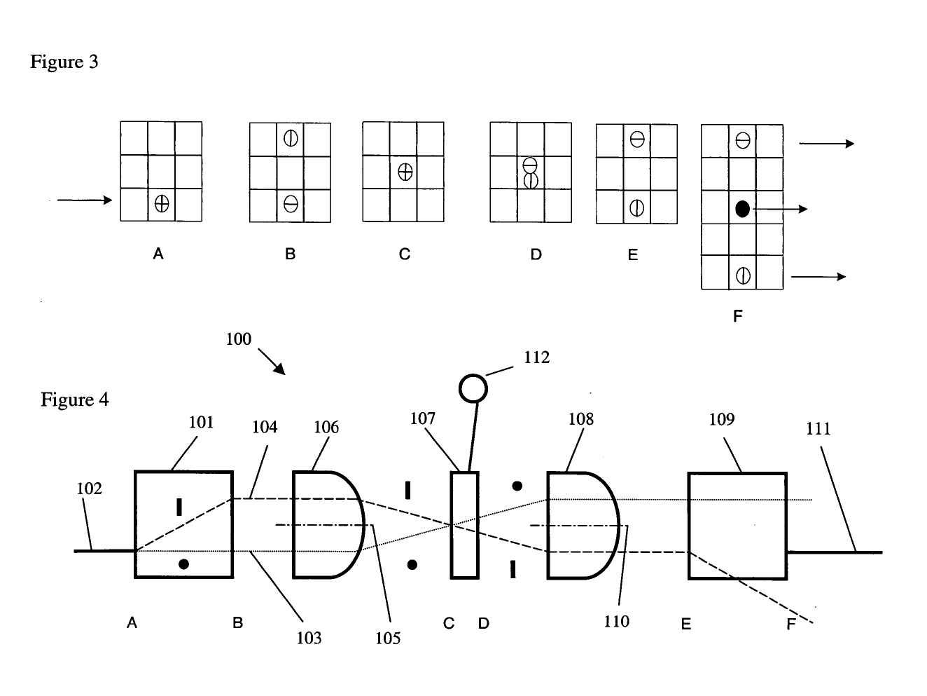

FIGS. 3 and 4 illustrate the variable optical attenuator 100 providing 100% attenuation. At Position A the input beam of light is illustrated as having mixed polarizations entering into the first birefringent crystal 101. By Position B, the first and second sub-beams 103 and 104 are orthogonally polarized and spatially separated. The first lens 106 redirects the first and second sub-beams 103 and 104 along paths converging to the same point of entry into the variable polarization rotator 107 (Position C). In the example given in FIGS. 3 and 4, the variable polarization rotator 107 provides no polarization rotation, therefore the sub-beams 103 and 104 maintain the same polarization therethrough to Position D, but with a slight spatial separation. By Position E, the sub-beams 103 and 104 have traveled along diverging paths (in collimated space) resulting in even more spatial separation. Since the states of polarization of the first and second sub-beams 103 and 104 were not altered by the variable polarization rotator 107, the first sub-beam 103 continues through the second birefringent crystal 109 parallel to the output waveguide 111, while the second sub-beam 104 is walked off away from the output waveguide 111. Accordingly, the input light is fully attenuated, as not light is directed to the output waveguide 111.

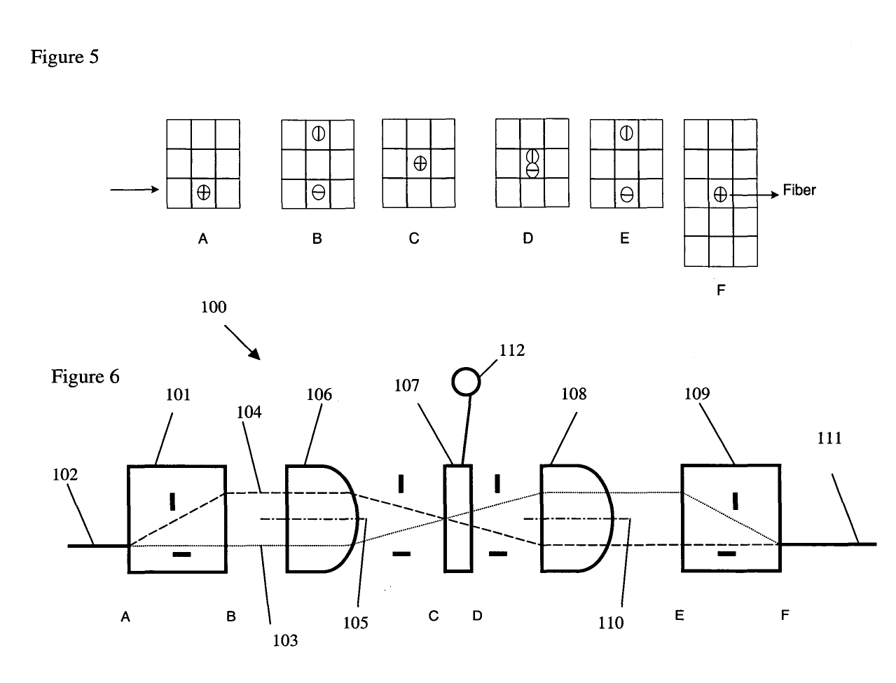

FIGS. 5 and 6 illustrate the variable optical attenuator 100 providing no attenuation. In this example, Positions A, B and C are identical to those detailed hereinbefore. However, in this example, the variable polarization rotator 107 is set to rotate the state of polarization of both of the first and second sub-beams 103 and 104 by 90°. Accordingly, after the second lens 108 directs the first and second sub-beams 103 and 104 along parallel paths to the second birefringent crystal 109, the first sub-beam (now vertically polarized) and the second sub-beam (now horizontally polarized) are directed to the input end of the output waveguide 111.

Ideally, the first and second lenses 106 and 108 are positioned equidistant from the variable polarization rotator 107, whereby the first and second sub-beams travel the same optical path length from Position B to Position E. Moreover, the first and second birefringent crystals 101 and 109 are manufactured and arranged so that the combined optical path length for the first and second sub-beam 103 and 104 traveling therethrough is equal. For simplicity, the first and second birefringent crystals 101 and 109 are made from the same material, e.g. rutile, and have the same thickness (t₁=t₂). Due to the fact that the first and second sub-beams 103 and 104 travel substantially equal optical path lengths through the variable optical attenuator 100, polarization mode dispersion (PMD) is greatly limited. However, in certain instances when the device of the present invention is combined with another optical device, the thicknesses t₁ and t₂ of the first and/or the second birefringent crystals 101 and 109 can be altered to induce PMD, and thereby cancel any PMD from the other optical device.

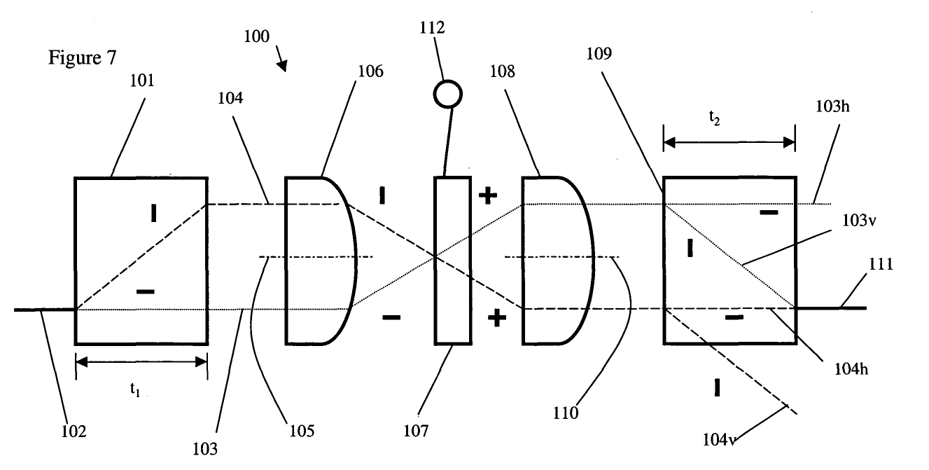

The example illustrated in FIG. 7 represents the variable optical attenuator 100 according to the present invention with an attenuation between 0% and 100%. Again, Positions A, B and C are identical to those detailed hereinbefore. However, in this case, the variable polarization rotator 107 is adjusted to rotate the polarization of the first and second sub-beams 103 and 104 by an amount greater than 0°, but less than 90°. Accordingly, the first and second sub-beams 103 and 104 exit the variable polarization rotator 107 with mixed states of polarization, i.e. with a component horizontally polarized 103h and 104h, and a component vertically polarization 103v and 104v, respectively. As a result, when the first sub-beam 103 enters the second birefringent crystal 109, the horizontal component 103h continues straight through along a path parallel to the output waveguide 111, while the vertical component 103v is directed to the input end of the output waveguide 111. Similarly, the vertical component 104v of the second sub-beam 104 is spilled off away from the input end of the output waveguide 111, while the horizontal component 104h is recombined with the vertical component 103v of the first sub-beam 103, and enters the output waveguide 111.

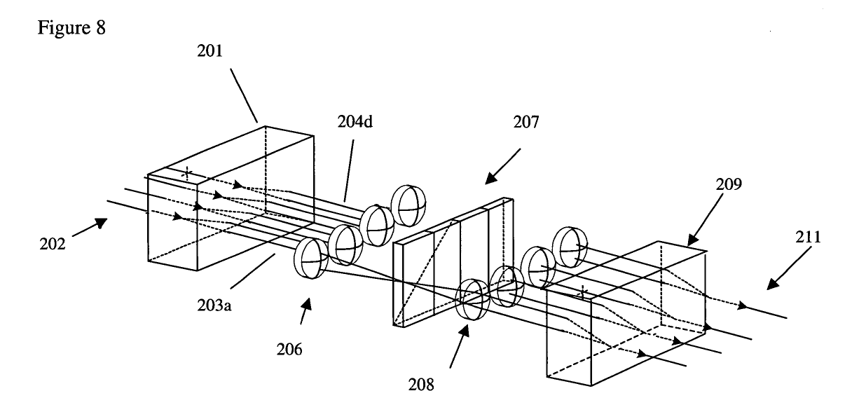

With reference to FIG. 8, another advantage of the design of the present invention is illustrated by an array of variable optical attenuators 200, which is able to use a first strip of birefringent material 201 optically coupled to an array of input waveguides 202 for splitting a series of input signals into a series of first and second sub-beams 203a to 203d and 204a to 204d. A micro lens array 206 directs the first and second sub-beams 203a to 203d and 204a to 204d through a series of variable polarization rotators, in the form of a liquid crystal array 207. A second array of micro lenses 208 directs the first and second sub-beams 203a to 203d and 204a to 204d from the diverging paths (in collimated space) to parallel paths (in converging space) for entry into a second strip of birefringent material 209. As hereinbefore discussed, the second strip of birefringent material 209 combines the desired amount of light from each input signal for output an array of output waveguides 211. Since the light from each waveguide of the input waveguide array 202 continuously travels in the same plane, as seen in FIGS. 4, 6 and 7, and illustrated as the middle column in FIGS. 3 and 5, the array of variable optical attenuators 200 can be constructed in a very compact package by positioning the plane corresponding to each input waveguide parallel to each other. As an example: an 8 mm long rutile strip having a thickness of 250 μm and a height of less that 1 mm enables an array of up to 32 fibers separated by 250 um to be optically coupled.

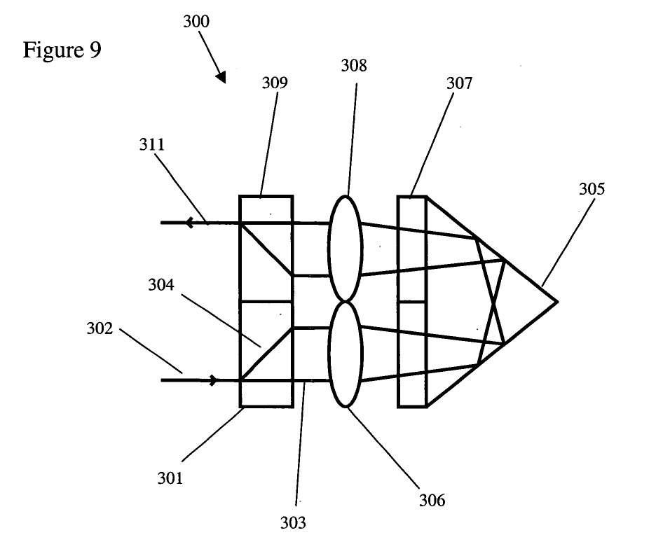

FIG. 9 represents another embodiment of the present invention, in which a variable optical attenuator 300 is in a folded configuration. A birefringent crystal 301 is used to split light from an input waveguide 302 into first and second sub-beams 303 and 304, which are directed by a first lens 306 through a variable polarization rotator 307. In this embodiment, a retro-reflective element, preferably in the form of a corner cube prism 305, is used to redirect the first and second sub-beams 303 and 304 back along paths generally parallel to their original paths, whereby a second lens 308 directs the first and second sub-beams 303 and 304 through the second birefringent crystal 309 to an output waveguide 311, which is substantially parallel to the input waveguide 302. The variable polarization rotator 307 may be positioned between the first lens 306 and the corner cube 305 or between the corner cube 305 and the second lens 308. Alternatively, the variable polarization rotator 307 may be made up of two separate liquid crystal cells, each rotating the polarization of the sub-beams by half the required amount.

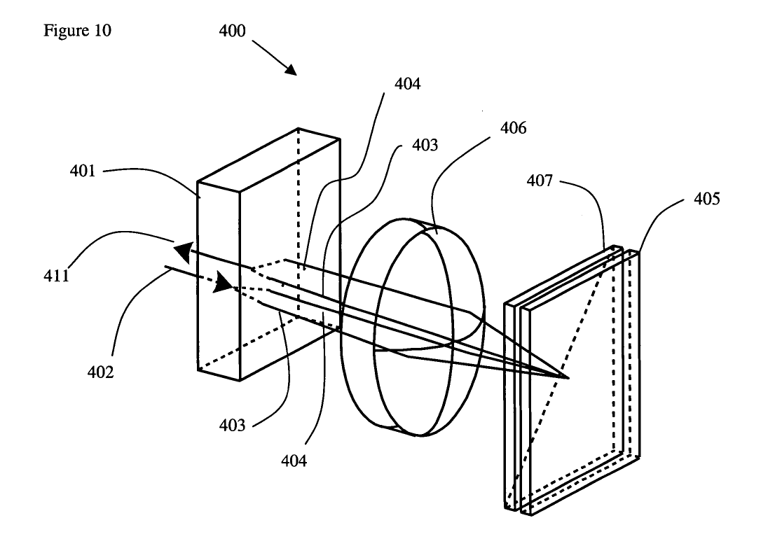

FIG. 10 illustrates another embodiment of a reflected version of the variable optical attenuator 400, which includes a single birefringent crystal 401 for separating an input beam of light launched from input waveguide 402 into first and second sub-beams 403 and 404. The sub-beams 403 and 404 pass through a collimating lens 406 on opposite sides of one half thereof, so that the sub-beams 403 and 404 are redirected to the same spot on a liquid crystal cell 407, and so that they are incident upon the liquid crystal cell 407 with a slight angle. A reflective surface 405, positioned behind the liquid crystal cell 407, reflects the sub-beams 403 and 404 back through the other half of the lens 406 to an output waveguide 411.

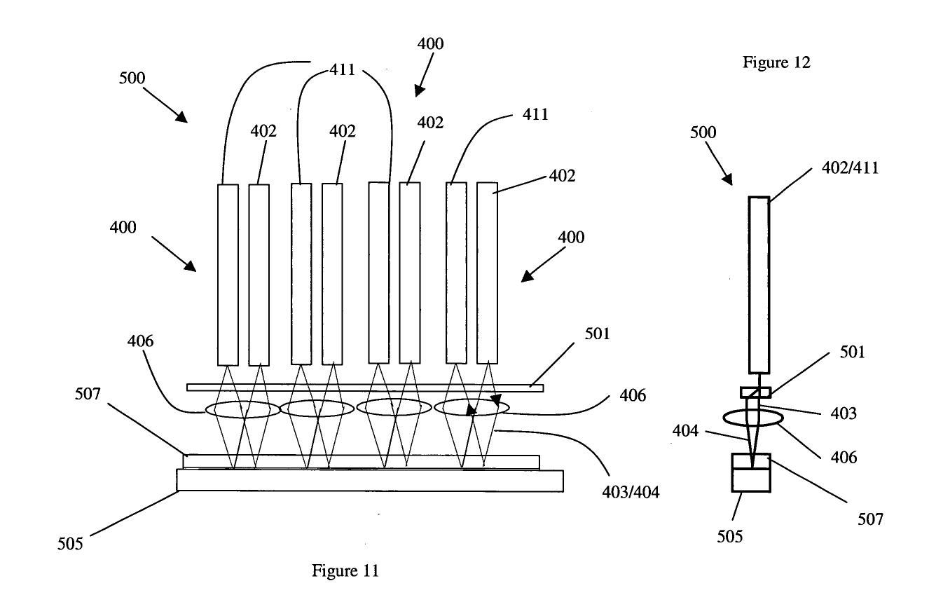

With reference to FIGS. 11 and 12, an array 500 of variable optical attenuators 400 is illustrated from the top and the side. The array 500 uses one long strip of birefringent material 501, one strip of reflective material 505, and a liquid crystal array 507 with individually controllable cells.

We claim:

1. A variable optical attenuator device comprising:
an input port for launching an input beam of light;
a polarization beam splitter for dividing the input beam into first and second orthogonally polarized sub-beams;
a first lens for collimating the first and second sub-beams, and for redirecting the first and second sub-beams along crisscrossing paths;
a variable polarization rotator disposed in the crisscrossing paths for rotating the polarization of the first and the second sub-beam by a desired amount, whereby each of the first and second sub-beams has first and second orthogonally polarized components;
a second lens for focusing the first and second sub-beams, and for redirecting the first and second sub-beams along substantially parallel paths;
a polarization beam combiner disposed in the parallel paths for combining the first component of the first sub-beam with the second component of the second sub-beam into an output beam; and
an output port for outputting the output beam.

2. The device according to claim 1, wherein the crisscrossing paths intersect proximate the variable polarization rotator, whereby both the first and second sub-beams enter the variable polarization rotator at substantially the same point.

3. The device according to claim 1, wherein the variable polarization rotator is disposed proximate a focal plane of the first lens, whereby the crisscrossing paths intersect proximate the variable polarization rotator.

4. The device according to claim 1, wherein the first and second sub-beams travel through the polarization beam splitter, along the crisscrossing paths, and through the polarization beam combiner in substantially a single plane.

5. The device according to claim 1, further comprising a reflective element between the first lens and the variable polarization rotator or between the polarization rotator and the second lens for redirecting the first and second sub-beams.

6. The device according to claim 5, wherein the reflective element is a retro-reflective element for redirecting the first and second sub-beams back through the second lens and the polarization beam combiner, whereby the output waveguide is substantially adjacent the input waveguide.

7. The device according to claim 5, wherein the first and second lenses comprise a single lens, which redirects the first and second sub-beams twice; and wherein the first and second birefringent elements comprise a single birefringent crystal, which separates and combines the input beam and the output beam, respectively.

8. The device according to claim 1, wherein the polarization beam splitter is sized to receive a plurality of input beams, and divide each of the plurality of input beams into a plurality of first and second sub-beams;
wherein the device further comprises:
a plurality of first lenses for redirecting the plurality of first and second sub-beams along respective crisscrossing paths;
an array of variable polarization rotators for rotating the polarizations of each of the plurality of first and the second sub-beams, respectively, by desired amounts, whereby each of the first and second sub-beams have first and second orthogonally polarized components; and
a plurality of second lenses for redirecting the plurality of first and second sub-beams along substantially parallel paths; and
wherein the polarization beam combiner is sized to receive the plurality of first and second sub-beams for combining respective first components of the first sub-beams with the second components of the second sub-beams.

9. The device according to claim 8, further comprising a reflective element between the first plurality of lenses and the second plurality of lenses for reflecting the first and second sub-beams therebetween.

10. The device according to claim 8, wherein the first and second pluralities of lenses comprise a single array of lenses, which redirects the plurality of first and second sub-beams twice; and wherein the first and second birefringent elements comprise a single birefringent element, which divides and combines the input and output beams, respectively.

11. The device according to claim 1, wherein the polarization beam splitter is a first birefringent crystal; and wherein the polarization beam combiner is a second birefringent crystal.

12. The device according to claim 11, wherein the first and second birefringent crystals induce an optical path length difference between the first and second sub-beams, thereby inducing a predetermined polarization mode dispersion.

13. The device according to claim 1, wherein the variable polarization rotator is a liquid crystal cell.

14. A variable optical attenuator comprising:
a plurality of input ports for launching a plurality of input beams;
a polarization beam splitter for dividing each of the plurality of input beams into first and second sub-beams;
a first array of lenses, each lens for directing one of the first and one of the second sub-beams along crisscrossing paths;
an array of variable polarization rotators, each variable polarization rotator for rotating the polarization of one of the first and one of the second sub-beams, whereby each of the first and second sub-beams has first and second components;
a second array of lenses, each lens for directing one of the first and one of the second sub-beams along substantially parallel paths;
a polarization beam combiner for combining the first components of the first sub-beams with the second components of the second sub-beams, respectively, forming a plurality of output beams; and
a plurality of output ports for outputting the plurality of output beams.

15. The device according to claim 14, wherein each of the crisscrossing paths intersects proximate one of the variable polarization rotators, whereby each of the first and second sub-beams enter respective variable polarization rotators at substantially the same point.

16. The device according to claim 14, wherein the array of variable polarization rotators is disposed in a focal plane of the first array of lenses, whereby the crisscrossing paths intersect proximate thereto.

17. The device according to claim 14, further comprising a reflective element between the first array of lenses and the second array of lenses for reflecting the first and second sub-beams therebetween.

18. The device according to claim 14, wherein the first and second arrays of lenses comprise a single array of lenses, which redirects the plurality of first and second sub-beams twice; and wherein the first and second birefringent elements comprise a single birefringent element, which divides and combines the input and output beams, respectively.

19. The device according to claim 14, wherein the polarization beam splitter is a first birefringent crystal; and wherein the polarization beam combiner is a second birefringent crystal.

20. The device according to claim 14, wherein the variable polarization rotator is a liquid crystal cell.
